(19) United States
(12) Patent Application Publication
(10) Pub. No.: US 2021/0029304 A1
(43) Pub. Date: Jan. 28, 2021

(54) METHODS FOR GENERATING VIDEO, ELECTRONIC DEVICE AND STORAGE MEDIUM

(71) Applicant: Beijing Dajia Internet Information Technology Co, Ltd., Beijing (CN)

(72) Inventors: Ying SHU, Beijing (CN); Ying ZHANG, Beijing (CN)

(21) Appl. No.: 16/936,102

(22) Filed: Jul. 22, 2020

(30) Foreign Application Priority Data
Jul. 22, 2019 (CN) 201910662095.6

(51) Int. Cl. H04N 5/262; H04N 5/272; H04N 5/278

(52) U.S. Cl. CPC H04N 5/2621; H04N 5/278; H04N 5/272

(57) ABSTRACT

Disclosed is a method for generating a video. The method can include: in response to a select operation on a special-effect sticker, displaying interaction information corresponding to the special-effect sticker; acquiring interaction content from a user, the interaction content being generated based on the interaction information; acquiring a first video to be displayed, the first video being generated based on the special-effect sticker; and generating a second video based on the first video and an additional special effect that matches the interaction content.

This application is based on and claims priority under 35 U.S.C. 119 to Chinese patent application No. 201910662095.6, filed on Jul. 22, 2019, in the China National Intellectual Property Administration, the disclosure of which is herein incorporated by reference in its entirety.

### TECHNICAL FIELD

The present disclosure relates to the field of video technologies, and in particular, relates to a method for generating a video, and an electronic device, and a storage medium.

### BACKGROUND

With the development of science and technology, more and more users are passionate in shooting videos using electronic devices to shoot videos. When shooting the videos, the users also like to implant magic stickers to the videos to beautify or uglify the shot images or make the images more entertaining and ornamental. For example, when shooting the videos, the users may choose beauty-like magic stickers to make characters in the videos beautiful. However, the captured videos only including the magic stickers chosen by the users create less entertainment. Therefore, how to generate videos abundant in contents with reference to more factors is the focus of the industry.

### SUMMARY

Embodiments of the present disclosure are intended to provide a method for generating a video, and an electronic device, and a storage medium. The technical solutions of the present disclosure are described hereinafter.

In one aspect, embodiments of the present disclosure provide a method for generating a video. The method is applicable to an electronic device, and includes: displaying interaction information corresponding to the special-effect sticker in response to a select operation on a special-effect sticker; acquiring interaction content from a user, the interaction content being generated based on the interaction information; acquiring a first video to be displayed, the first video being generated based on the special-effect sticker; and generating a second video based on the first video and an additional special effect that matches the interaction content.

In another aspect, an embodiment of the present disclosure provides an electronic device. The electronic device includes: a processor; and a memory configured to store at least one instruction executable by the processor.

The processor is configured to execute the at least one instruction stored in the memory to: display interaction information corresponding to the special-effect sticker in response to a select operation on a special-effect sticker; acquire interaction content from a user, the interaction content being generated based on the interaction information; acquire a first video to be displayed, the first video being generated based on the special-effect sticker; and generate a second video based on the first video and an additional special effect that matches the interaction content.

In yet another aspect, embodiments of the present disclosure provide a non-transitory computer-readable storage medium storing at least one instruction therein. The at least one instruction, when executed by a processor of an electronic device, enables the electronic device to: display interaction information corresponding to the special-effect sticker in response to a select operation on a special-effect sticker; acquire interaction content from a user, the interaction content being generated based on the interaction information; acquire a first video to be displayed, the first video being generated based on the special-effect sticker; and generate a second video based on the first video and an additional special effect that matches the interaction content.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a method for generating a video in accordance with an embodiment of the present disclosure;

FIG. 2 is a flowchart of another method for generating a video in accordance with an embodiment of the present disclosure;

FIG. 3 is an example diagram of test content in a method for generating a video in accordance with an embodiment of the present disclosure;

FIG. 4 is a block diagram of a system for generating a video in accordance with an embodiment of the present disclosure;

FIG. 5 is a block diagram of an electronic device in accordance with an embodiment of the present disclosure; and

FIG. 6 is a block diagram of another electronic device in accordance with an embodiment of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the present disclosure as recited in the appended claims.

A method for generating a video, according to an embodiment of the present disclosure, is applicable to an electronic device. Optionally, the electronic device is a desktop computer, an intelligent mobile terminal, a notebook computer, a tablet computer, an Internet TV, a wearable intelligent terminal, or the like. Any electronic device capable of generating a video is applicable to the present disclosure, which is thus not limited herein.

In an embodiment of the present disclosure, a target application in the electronic device supports not only generation of a video to be displayed based on a magic sticker selected by a user, but also interaction with the user based on the magic sticker. In some embodiments, in response to detecting that selection of the magic sticker is completed, the electronic device displays test content corresponding to the selected magic sticker. Reference information is generated based on the test content. In the case that the video to be displayed is obtained, a test result and the video to the displayed are co-displayed.

In some embodiments, the target application is any application that supports video recording, e.g., the target application is a short-video application, a camera or the like. The magic sticker is any type of application in the target application, e.g., the magic sticker is a special-effect sticker, a memes battle sticker or the like. The test content is interaction information between the electronic device and the user. In some embodiments, the test content is to be provided for the user to obtain the reference information generated by the user based on the test content, i.e., interaction content. The test result is an additional special effect that matches the interaction content.

The method for generating the video, according to the embodiment of the present disclosure, will be introduced first in detail below.

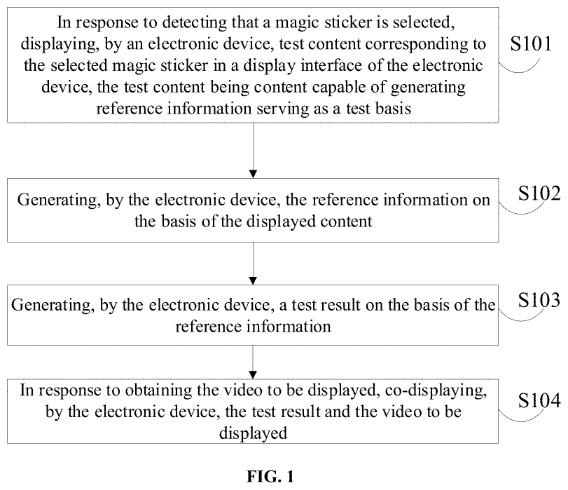

FIG. 1 is a flowchart of a method for generating a video in accordance with an exemplary embodiment. The generated video may meet personalized demands of users. As shown in FIG. 1, the method for generating the video includes the following steps.

In step S101, in response to detecting that a magic sticker is selected, an electronic device displays test content corresponding to the selected magic sticker in a display interface of the electronic device. The test content is content capable of generating reference information serving as a test basis.

In some embodiments, the test content is interaction information between the electronic device and a user. In some embodiments, the test content is to be provided for the user to obtain the reference information generated by the user based on the test content, i.e., interaction content. In some embodiments, the test content may be in various different forms, e.g., the test content is content about a psychological test. Optionally, the test content is a psychological test about personality, a psychological test about spouse preference, a psychological test about gemstones, or the like. In some embodiments, the test content is content that acquires user's wishes. For example, the test content is about inquiry of a New Year's wish of the user, a birthday wish of the user, a career vision of the user, or the like. In some embodiments, the test content is provided by the electronic device to a user interface for the user to perform some operations, e.g., dragging a picture to a specific location and inputting a text, a video, a picture, an audio, and the like Any test content that may be used for generating the reference information for the user is applicable to the present disclosure, which is thus not limited in the present embodiment.

In some embodiments, the interaction content includes at least one of a subject-specific option, a dragged picture material in the display interface, a placement location of the dragged picture material, an input text, an input emoji, an uploaded picture, an uploaded video, and a shot picture.

In some embodiments, the magic sticker includes any one of a special-effect sticker, a meme battle stick, and the like.

In order to ensure that display effects of the video to be displayed in the subsequent step S104 include not only the magic sticker but also a display effect relevant to the user so as to be improved in diversification and personalization, in response to detecting that the selection of the magic sticker is completed, the test content corresponding to the selected magic sticker is displayed in the display interface of the electronic device. In addition, the test content is content capable of generating the reference information serving as the test basis, so as to generate a test result related to the user per se in subsequent steps S102 to S103. Further, the test result and the video to be displayed are co-displayed in step S104.

The test content may be in various forms. For example, the test content is in the form of voice, a text, and/or a picture. Optionally, there may be various corresponding relationships between the magic sticker and the test content. Exemplarily, different magic stickers correspond to different test content, and the magic stickers are in one-to-one correspondence with the test content. For example, the magic sticker “New Year keywords” corresponds to the test content about New Year's wishes, and the magic sticker “send red packet” corresponds to the test content about career visions. Alternatively, the same magic sticker corresponds to different test content, and one magic sticker corresponds to multiple test content. For example, the magic sticker “New Year keywords” corresponds to test content about New Year's wishes, a psychological test about spouse preference, test content about career visions, and the like. Any corresponding relationship between the magic sticker and the test content is applicable to the present disclosure, which is thus not limited in this embodiment. Alternatively, multiple magic stickers correspond to the same test content.

In step S102, the electronic device generates the reference information based on the displayed test content.

The reference information is the interaction content generated by the user. The interaction content includes at least one of a subject-specific option, a dragged picture material in the display interface, a placement location of the dragged picture material, an input text, an input emoji, an uploaded picture, an uploaded video, and a shot picture. That is, the reference information is at least one of a subject-specific option, a dragged picture material in the display interface, a placement location of the dragged picture material, an input text, an input emoji, an uploaded picture, an uploaded video, and a shot picture.

The different reference information may be correspondingly acquired in various ways, is explained hereinafter by optional embodiments.

In some embodiments, the reference information includes a subject-specific option. In some embodiments, the electronic device displays the reference information corresponding to the displayed test content in the form of an option, and the user taps the displayed option to select the reference information that matches the user per se; alternatively, when the reference information is not displayed in the form of an option, the user may input content corresponding to the test content as the reference information. For example, a series of tests and corresponding options may be displayed to the user, and the option selected by the user is the reference information.

In some embodiments, the test information includes the dragged picture material in the display interface and/or the placement location of the dragged picture material. In some embodiments, the electronic device displays at least one picture material, allowing the user to select to drag and place it in a certain position on a screen. Then, the picture material dragged by the user and/or the position where the picture material is placed are the reference information.

In some embodiments, the test content is an input text and/or emoji. In some embodiments, the electronic device displays a text input box or an editor, the user inputs a custom text and/or an emoji into the text input box or the editor, and the electronic device takes the content input into the text input box or the editor as the reference information.

In some embodiments, the test content is an uploaded video and/or an uploaded picture. In some embodiments, the electronic device acquires the picture and the video uploaded by the user, and uses the content uploaded by the user as the reference information. The electronic device regards uploading as a form of input.

In some embodiments, step S102 includes: receiving, by the electronic device, content selected by the user and uses the content selected by the user as the reference information; and alternatively, by the electronic device, receiving content input by the user and using the content input by the user as the reference information. The reference information includes at least one of a picture, a text, an audio, and a video.

In some embodiment, the reference information is the content selected or input by the user. Therefore, the electronic device directly uses the content selected by the user as the reference information, or uses the content input by the user as the reference information. Compared with a method requiring identification of the received content, the above method may omit the process of identifying the content, and thus may relatively improve the efficiency in acquiring the reference information, thereby improving the efficiency in video generation. In addition, the diversified reference information, including at least one of a picture, a text, an audio, and a video, may be utilized to improve the diversification of the display effects.

Exemplarily, the test content displays at least one of a picture, a text, an audio, and a video in the form of options. At this time, the user selects any one of the options, and the electronic device receives the selected content, and uses the selected content as the reference information. Alternatively, the electronic device displays a content input box and/or a content input button corresponding to the test content. At the moment, the user inputs at least one of a picture, a text, an audio, and a video via the content input box and/or the content input button, and the electronic device receives the input content, and uses the input content as the reference information.

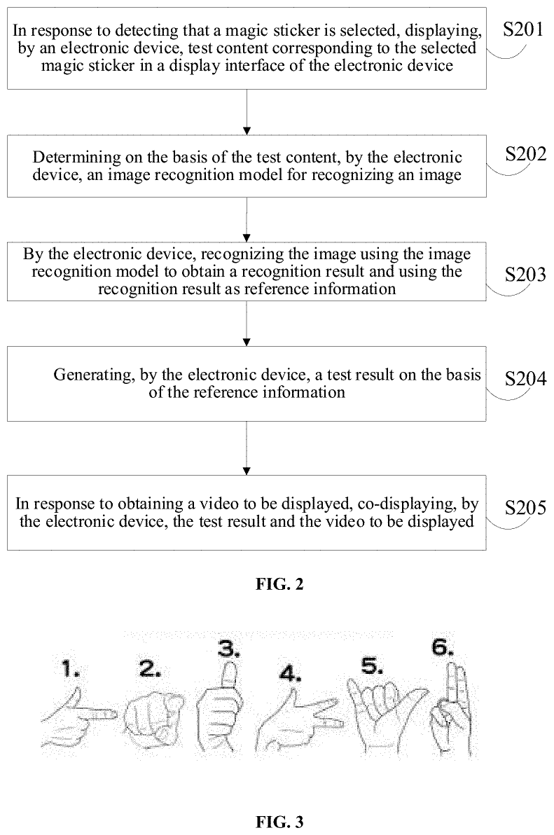

In another optional embodiment, the reference information includes an image collected by a camera of the electronic device. Correspondingly, step S102 includes, recognizing, by the electronic device, the collected image to obtain a recognition result, and using the recognition result as the reference information. For the ease of understanding and reasonable layout, this optional embodiment is described hereinafter in the embodiment of FIG. 2. Any method of acquiring the reference information is applicable to the present disclosure, which is thus not limited in this embodiment.

In step S103, the electronic device generates a test result based on the reference information.

The test result is an additional special effect that matches the reference information. There are many ways for the electronic device to generate the test result based on the reference information, which is explained hereinafter by optional embodiments.

In one optional embodiment, step S103 includes: searching for, by the electronic device, a test result corresponding to the acquired reference information from a pre-stored corresponding relationship between the reference information and the test result. The test result includes at least one of a picture, a text, an audio, and a video.

Different reference information corresponds to different test results. Therefore, the electronic device pre-stores the corresponding relationship between the reference information and the test result so as to search for the test result corresponding to the acquired reference information from the corresponding relationship between the reference information and the test result based on the acquired reference information. For example, the pre-stored corresponding relationship between the reference information and the test results includes: the reference information “make progress in your studies” corresponds to the test result “never fail any exam”, and the reference information “have fair skin and be slender” corresponds to the test result “dreamboat”. In the case that the acquired reference information is “Make progress in your studies”, the test result is “Never fail any exam”. In addition, in order to improve the diversification of the display effects, the test result may be at least in one of the following forms: a picture, a text, an audio, and a video.

In another optional embodiment, step S103 includes: converting, by the electronic device, the reference information into information in a specified format to obtain a test result. The test result includes at least one of a picture, a text, an audio, and a video.

Various specified formats may be provided. Exemplarily, the specified format is at least one of a text format, a picture format, an audio format, and a video format. At this time, in response to information that the reference information is in a specified format, the electronic device directly uses the reference information as the test result.

In response to information that the reference information is not in the specified format, the electronic device recognizes content of the reference information and expresses the content of the reference information in the specified format, thereby converting the reference information into the information in the specified format. For example, in the case that the reference information is a picture, the electronic device recognizes texts in the picture and uses the recognized texts as the test result in a text format; or, the electronic device converts the recognized texts into speech to obtain a test result in an audio format; or, the electronic device encodes the picture into a video to obtain the test result in a video format. Similarly, in the case that the reference information is texts, the electronic device performs text rendering to obtain a test result in a picture format; or, the electronic device encodes the rendered picture into a video to obtain a test result in a video format; or, the electronic device converts the texts into speech to obtain a test result in an audio format. Any method for generating the test result is applicable to the present disclosure, which is thus not limited in this embodiment.

In another optional embodiment, the reference information and the test result may not be in the same format. The diversified display effects increased by the test result are unpredictable for the user. Therefore, the display effects may be less monotonous but diversified.

In step S104, in response to obtaining the video to be displayed, the electronic device co-displays the test result and the video to be displayed.

The video to be displayed is a first video generated based on the selected magic sticker. Co-displaying the test result and the video to be displayed is to generate a second video based on the video to be displayed and the test result and to play the second video to achieve the effect of co-displaying the additional special effect and the first video.

In some embodiments, the test result and the video to be displayed may be co-displayed in multiple ways. Exemplarily, the electronic device synthesizes the test result in the video to be displayed, such that the displayed video to be displayed may contain the test result, and thus, the test result and the video to be displayed are co-displayed. Alternatively, the electronic device regards the test result and the video to be displayed as independent content, and the test result is displayed in the process of displaying the video to be displayed to practice co-display of the test result and the video to be displayed. In order to facilitate understanding and reasonable layout, the method for co-displaying the test result and the video to be displayed is described by an optional embodiment hereinafter.

Moreover, acquiring the video to be displayed includes: receiving a video recording instruction by the electronic device; collecting, based on the instruction, image frames using the camera of the electronic device; and obtaining the video to be displayed by synthesizing the collected image frames. The selected magic sticker is added to the synthesized video to be displayed to ensure that the video to be displayed has a display effect of the selected magic sticker. Besides, step S103 is performed prior to or upon acquiring the video to be displayed, or at the same time as the step of acquiring the video to be displayed.

The technical solutions according to the embodiments of the present disclosure include the following beneficial effects: upon detection that the selection of the magic sticker is completed, the test content corresponding to the selected magic sticker is displayed in the display interface of the electronic device; and the test content is the content capable of generating the reference information serving as the test basis. Therefore, based on the displayed test content, the generated reference information is information relevant to the user's own selection. Different reference information will be generated when different users make different choices. Further, different test results can be generated for different reference information when the test results are generated based on the reference information, and the test results can reflect the users' personalized choices relevant to the users. Therefore, co-displaying the test result and the video to be displayed in response to obtaining the video to be displayed is equivalent to displaying, with respect to the different choices of the different users, a video display effect corresponding to the personalized choice relevant to the user in the video display effects of the video to be displayed. Compared with using only the selected magic sticker as a single video effect, co-displaying can improve the diversification and the personalization of the video effects. It can be seen that in the technical solutions according to the present disclosure, the test result relevant to the user may be generated by the reference information selected by the user, and the video display effect corresponding to the test result is added to the video to be displayed, such that the relevance of the video display effect to the user is guaranteed, and the video effects are improved in diversification and personalization.

FIG. 2 is a flowchart of another method for generating a video in accordance with an exemplary embodiment. This embodiment takes that interaction content is a shot image as an example for explanation. As shown in FIG. 2, the method for generating the video includes the following steps.

In step S201, in response to detecting that a magic sticker is selected, an electronic device displays test content corresponding to the selected magic sticker in a display interface of the electronic device. The test content is content capable of generating reference information serving as a test basis. The reference information includes an image collected by a camera of the electronic device upon display of the test content.

Step S201 is similar to step S101 of the embodiment in FIG. 1 of the present disclosure, and their difference lies in that in step S201, the reference information is the image collected by the camera of the electronic device upon display of the test content. Besides, various collected images may exist. Exemplarily, the collected image is at least one of a human face, a gesture, a designated item, a body posture, and the like.

In addition, in some embodiments, the electronic device starts to collect the image in response to displaying the test content in the display interface. In another optional embodiment, the electronic device may not start to collect the image until it receives a collection instruction triggered by a user.

In some embodiments, the electronic device directly executes step S202 in response to collecting the image. In some embodiments, in response to collecting the image, the electronic device determines whether the image is an image of a specified content type; in the case that the image is an image of a specified content type, the electronic device executes step S202; and in the case that the image is not an image of a specified content type, the electronic device re-collects an image till the recollected image is of a specified content type.

For example, if the test content is intended to prompt the user to make a specified gesture, the specified content type is a gesture type; and if the test content is intended to prompt the user to make a specified facial expression, the specified content type is a facial expression type.

In step S202, the electronic device determines, based on the test content, an image recognition model for recognizing an image.

Since the reference information corresponds to the test content, the electronic device determines, based on the test content, the image recognition model for recognizing the image. In addition, the electronic device pre-stores a corresponding relationship between the test content and the image recognition model. In some embodiments, that the electronic device determines, based on the test content, the image recognition model for recognizing the image includes: according to the test content, the electronic device searches for the image recognition model corresponding to the displayed test content from the pre-stored corresponding relationship between the test content and the image recognition model.

Exemplarily, the pre-stored corresponding relationship between the test content and the image recognition model includes: the test content that instructs the user to make a specified gesture corresponds to the image recognition model for recognizing the gesture. For example, as shown in FIG. 3, if the test content is intended to instruct the user to make one of six gestures displayed, the displayed test content is a test content that instructs the user to make a specified gesture. Therefore, the electronic device determines the image recognition model for recognizing the gesture as the image recognition model for recognizing the collected image.

In addition, the pre-stored corresponding relationship between the test content and the image recognition model also includes: a test content that instructs the user to make a specified facial expression corresponds to the image recognition model for recognizing a human face; a test content that instructs the user to make a specified body posture corresponds to the image recognition model for recognizing a body posture; and a test content that instructs the user to shoot a designated item corresponds to the image recognition model for recognizing the designated item. There may be various designated items. Exemplarily, the designated items are designated animals, characters, texts, and the like.

In step S203, the electronic device recognizes the image using the image recognition model to obtain a recognition result and uses the recognition result as reference information.

The image recognition model is a neural network model trained in advance using multiple sample images and content tags of the multiple sample images. Moreover, content of the multiple sample images is of the same type as content of the collected image. Therefore, a recognition result of the content of the image may be obtained when the image recognition model is utilized to recognize the image. In addition, corresponding to different collected images, the content of the sample images may be of various types. Exemplarily, the content of the sample images is of a gesture type, a facial expression type, an item type, a body posture type, or the like. The image recognition model may be obtained by training in the following steps.

For any image content type, the electronic device inputs a plurality of sample images into an initial neural network model of the image content type for training, and obtains a predicted recognition result of each sample image of the image content type; according to the predicted recognition result of each sample image of the image content type, the corresponding content tag and a preset loss function, the electronic device determines whether the neural network model of the image content type in the current training stage has converged; in response to convergence of the neural network model in the current training stage, the electronic device determines the neural network model in the current training stage as the image recognition model of the image content type.

In response to non-convergence of the neural network model in the current training stage, the electronic device adjusts model parameters of the neural model in the current training state using a stochastic gradient descent model, to obtain the adjusted neural network model of the image content type; the electronic device inputs the multiple sample images into the adjusted neural network model of the image content type; and the electronic device repeats the above steps of training and model parameter adjustment until the adjusted neural network model of the image content type converges.

Moreover, since various initial neural network models are used during training of the image recognition model, correspondingly, various image recognition models are provided. Exemplarily, the image recognition model is a recurrent neural network model, a deep learning neural network model, a memory neural network model, or the like. Any image recognition model capable of recognizing the image content is applicable to the present disclosure, which is thus not limited in this embodiment.

In step S204, the electronic device generates a test result based on the reference information.

In step S205, in response to obtaining a video to be displayed, the electronic device co-displays the test result and the video to be displayed.

Steps S204 to S205 are the same as steps S103 to S104 of the embodiment in FIG. 1 of the present application, and thus are not described herein any further. For details, reference may be made to the description of the embodiment in FIG. 1 of the present disclosure.

In the embodiment of FIG. 2 described above, the reference information is not limited to be simply selected and input by the user, but in the form of human-computer interaction, enables the user to make specific gestures, postures, facial expressions, and the like, or allows the user to search for designated items for shooting, which, relatively speaking, improves the user's participation in the video generation process. Moreover, the diversification of the display effects of the video generated subsequently is improved by the unused reference information.

Optionally, in the case that the test result includes non-audio data, step S104 of the embodiment in FIG. 1 of the present disclosure, or step S205 of the embodiment in FIG. 2 includes: in response to obtaining the video to be displayed, by the electronic device, converting the test result into target image data; and synthesizing the target image data and a video frame of the video to be displayed into a video, and displaying the synthesized video.

In this optional embodiment, by converting the test result into the target image data, the electronic device uses the test result as a video frame in the video, such that the image data and the video frame of the video to be displayed can be synthesized into a video. The test result and the video to be displayed are contained in one video, and displaying the synthesized video is equivalent to co-displaying the video to be displayed and the test result. Therefore, the display effect of the displayed synthesized video includes the video to be displayed and the test result, and the video to be displayed itself includes a display effect of the magic sticker. Compared with only displaying the video to be displayed, co-displaying can improve the diversification and the personalization of the display effect of the generated video.

Exemplarily, in the case that the test result is image data, the electronic device directly synthesizes the test result and the video frame of the video to be displayed into a video. In the case that the test result is text data, the electronic device renders the text data into target image data, and then synthesizes the rendered target image data and the video frame of the video to be displayed into a video.

Optionally, in the case that the test result includes non-audio data, step S104 of the embodiment in FIG. 1 of the present disclosure or step S205 of the embodiment in FIG. 2 includes: by the electronic device, in response to obtaining the video to be displayed, obtaining the video to the displayed that contains the test result by adding the test result to the video frame of the video to be displayed, and displaying the video to be displayed that contains the test result.

In this optional embodiment, the test result may be added to the video frame as content in any video frame of the video to be displayed, thereby obtaining the video to be displayed that contains the test result. At this time, the display effect of the video to be displayed includes the test result. Therefore, displaying the video to be displayed that contains the test result is equivalent to co-displaying the video to be displayed and the test result.

There are many ways for the electronic device to add the test result to the video frame of the video to be displayed. Exemplarily, the electronic device renders the test result in the video frame of the video to be displayed. Or, exemplarily, the electronic device converts the test result into image data, and replaces pixels in the video frame of the video to be displayed with pixels of the image data. Any method that may add the test result to the video frame of the video to be displayed is applicable to the present disclosure, which is thus not limited in this embodiment.

Optionally, in the case that the test result includes non-audio data, step S104 of the embodiment in FIG. 1 of the present disclosure or step S205 of the embodiment in FIG. 2 includes: in response to obtaining the video to be displayed, displaying, by the electronic device, the test result in the display interface while displaying the video to be displayed in the display interface

In this optional embodiment, the test result and the video to be displayed are two independent content. Displaying the test result in the display interface while displaying the video to be displayed in the display interface is equivalent to displaying the test result, in addition to the video to be displayed, in the display interface. Therefore, co-display of the video to be displayed and the test result is practiced.

Optionally, in the case that the test result includes audio data, step S104 of the embodiment in FIG. 1 of the present disclosure or step S205 of the embodiment in FIG. 2 includes: in response to obtaining the video to be displayed, playing, by the electronic device, the test result while displaying the video to be displayed. A terminal synthesizes the audio data in the test result and the video frame of the video to be displayed, and plays the synthesized video, so as to co-display the test result and the video to be displayed.

In some embodiments, in the case that a first duration corresponding to the audio data in the test result is equal to a second duration corresponding to the video to be displayed, the electronic device correspondingly synthesizes, according to a timestamp, the audio data in the test result and the video frame in the video to be displayed.

In some embodiments, in the case that the first duration is greater than the second duration, the electronic device compresses the audio data in the test content according to second duration and correspondingly synthesizes, according to the timestamp, the compressed audio data in the test content and the video frame in the video to be displayed. Alternatively, the electronic device intercepts part of the audio data from the audio data in the test content according to the second duration, and correspondingly synthesizes, according to the timestamp, the part of intercepted audio data and the video frame in the video to be displayed.

In some embodiments, in the case that the first duration is less than the second duration, the electronic device synthesizes the audio data in the test content into part of the video frame in the video to be displayed.

In some embodiments, the video obtained by synthesizing, via the electronic device, the video to be displayed and the test content is a second video. The electronic device plays the second video in the display interface in a full-screen manner. Alternatively, the electronic device plays the second video in a first display area of the display interface. The first display area is part of an area in the display interface.

In the case that the electronic device plays the second video in the first display area, the electronic device plays a first video in a second display area of the display interface, such that the user may compare the played first video with the played second video to reflect the effect of the second video. The second display area is a display area other than the first display area in the display interface.

Another point to be noted is: in the case that the electronic device plays the second video in the first display area and the first video in the second display area, the electronic device displays only a video picture of the first video but not the audio data of the first video, thereby avoiding such problems as a cluttered audio effect caused by co-display of the first video and the second video.

In this optional embodiment, the test result may be used as the audio effect of the video to be displayed. Playing the test result while displaying the video to be displayed is equivalent to co-displaying the video to be displayed and the test result. Exemplarily, playing the test result while displaying the video to be displayed includes: in the process of displaying the video to be displayed, invoking an audio decoding process to decode the test result, and sending the decoded data to a playback process for play.

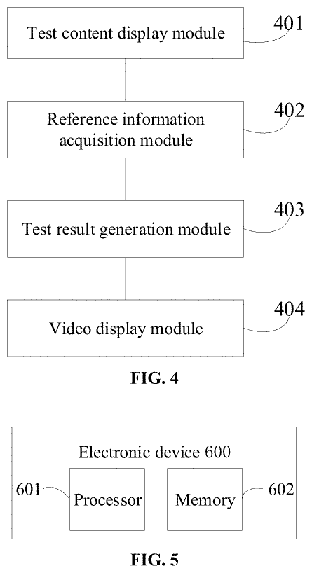

Corresponding to the above method embodiments, an embodiment of the present disclosure provides a system for generating a video, which is applied to an electronic device. As shown in FIG. 4, the system includes a processor. The processor is configured to implement functions of four modules, namely, a test content display module 401, a reference information acquiring module 402, a test result generating module 403, and a video display module 404.

The test content display module 401 is configured to display, in response to detecting that a magic sticker is selected, test content corresponding to the selected magic sticker in a display interface of an electronic device. The test content is content capable of generating reference information serving as a test basis.

The magic sticker is a special-effect sticker or a memes battle sticker. The test content is interaction information between the electronic device and a user. The test content is to be provided for the user, to obtain the reference information generated by the user based on the test content, i.e., the interaction content.

The reference information acquiring module 402 is configured to generate the reference information based on the displayed test content.

The test content is the interaction information, and the reference information is the interaction content.

The test result generating module 403 is configured to generate a test result based on the reference information.

Test information is the interaction content, and the test result is an additional special effect that matches the interaction content.

The video display module 404 is configured to co-display the test result and a video to be displayed in response to obtaining the video to the displayed.

The video to be displayed is a first video generated based on the selected magic sticker. Co-displaying the test result and the video to be displayed is to generate a second video based on the first video and the additional special effect that matches the interaction content.

The technical solution according to the embodiment of the present disclosure may include the following beneficial effects: in response to detecting that the selection of the magic sticker is completed, the test content corresponding to the selected magic sticker is displayed in the display interface of the electronic device; and, the test content is the content capable of generating the reference information serving as the test basis. Therefore, based on the displayed test content, the generated reference information is information relevant to the user's own selection. Different reference information will be generated when different users make different choices. Further, different test results can be generated for different reference information when the test results are generated based on the reference information, and the test results can reflect the users' personalized choices relevant to the users. Therefore, co-displaying the test result and the video to be displayed in response to obtaining the video to be displayed is equivalent to displaying, with respect to the different choices of the different users, a video display effect corresponding to the personalized choice relevant to the user in the video display effects of the video to be displayed. Compared with using only the selected magic sticker as a single video effect, co-displaying can improve the diversification and the personalization of the video effects. It can be seen that in the technical solutions according to the present disclosure, the test result relevant to the user may be generated by the reference information selected by the user, and the video display effect corresponding to the test result is added to the video to be displayed, such that the relevance of the video display effect to the user is guaranteed, and the video effects are improved in diversification and personalization.

Optionally, the reference information acquisition module 402 is configured to receive selected content and input content as the reference information in the case that the reference information includes the content selected from the test content or the input content corresponding to the test content. The reference information includes at least one of a picture, a text, an audio, and a video.

The reference information includes at least one of a subject-specific option, a dragged picture material in a display interface, a placement location of the dragged picture material, an input text, an input emoji, an uploaded picture, an uploaded video, and a shot picture.

Optionally, the test result generation module 403 is configured to search for a test result corresponding to the acquired reference information from a pre-stored corresponding relationship between the reference information and the test result. The test result includes at least one of a picture, a text, an audio, and a video.

The reference information is interaction content, and the test result is an additional special effect that matches the interaction content.

Optionally, the reference information acquisition module 402 is configured to: in the case that the reference information includes an image collected by a camera of the electronic device upon display of the test content, determine, based on the test content, an image recognition model for recognizing the image; and recognize the image by the image recognition model and obtain a recognition result and use the recognition result as the reference information.

Optionally, the video display module 404 is configured to: convert the test result that includes non-audio data into image data in response to obtaining the video to be displayed; and synthesize the image data and a video frame of the video to be displayed into a video, and display the synthesized video.

The image data is target image data corresponding to the additional special effect.

Optionally, the video display module 404 is configured to: in response to obtaining the video to be displayed, obtain the video to be displayed that contains the test result by adding the test result that includes the non-audio data to the video frame of the video to be displayed, and display the video to be displayed that contains the test result.

The video to be displayed is a first video generated based on the selected magic sticker, and co-displaying the test result and the video to be displayed is to generate a second video based on the first video and the additional special effect that matches the interaction content.

Optionally, the video display module 404 is configured to: in response to obtaining the video to be displayed, display the test result that includes the non-audio data in a display interface while displaying the video to be displayed in the display interface.

Optionally, the video display module 404 is configured to: in response to obtaining the video to be displayed, play the test result that includes audio data while displaying the video to be displayed.

The video to be displayed is a first video generated based on the selected magic sticker, and playing the test result while displaying the video to be displayed is to synthesize the audio data in the additional special effect and the video frame in the first video.

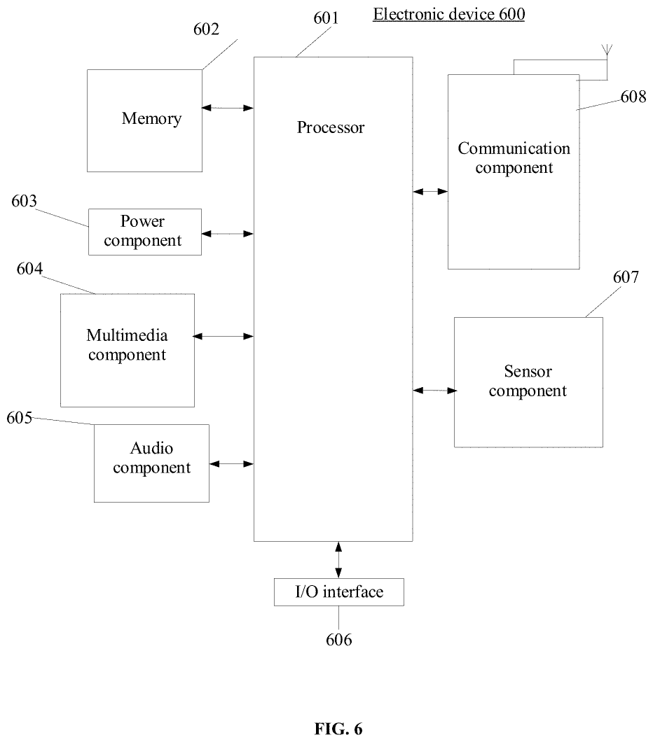

Corresponding to the above method embodiments, an embodiment of the present disclosure further provides an electronic device 600. As shown in FIG. 5, the electronic device 600 may include a processor 601, and a memory 602 configured to store at least one instruction executable by the processor.

The processor 601 is configured to execute the at least one instruction stored in the memory 602 to:

display interaction information corresponding to the special-effect sticker in response to a select operation on a special-effect sticker;

acquire interaction content from a user, the interaction content being generated based on the interaction information;

acquire a first video to be displayed, the first video being generated based on the special-effect sticker; and

generate a second video based on the first video and an additional special effect that matches the interaction content.

Optionally, the interaction content includes at least one of a subject-specific option, a dragged picture material in a display interface, a placement location of the dragged picture material, an input text, an input emoji, an uploaded picture, an uploaded video, and a shot picture.

Optionally, in the case that the additional special effect includes non-audio data, the processor 601 is configured to execute the executable instruction stored in the memory 602 to:

determine target image data corresponding to the additional special effect according to the additional special effect that matches the interaction content; and

synthesize the target image data and a video frame of the first video into a second video.

Optionally, in the case that the additional special effect includes non-audio data, the processor 601 is configured to execute the executable instruction stored in the memory 602 to obtain the second video containing the additional technical effect by adding the additional special effect to a video frame of the first video.

Optionally, in the case that the additional special effect includes audio data, the processor 601 is configured to execute the executable instruction stored in the memory 602 to obtain the second video containing the additional special effect by synthesizing the audio data in the additional special effect and a video frame of the first video.

Optionally, the processor 601 is configured to execute the executable instruction stored in the memory 602 to search for, according to the interaction content, the additional special effect that matches the interaction content from a pre-stored corresponding relationship between the interaction content and the additional special effect.

Optionally, the additional special effect includes at least one of a picture, a text, an audio, and a video.

Optionally, the processor 601 is configured to execute the executable instruction stored in the memory 602 to play the second video.

The technical solutions according to the embodiments of the present disclosure include the following beneficial effects: in the case that the user selects the special-effect sticker, the electronic device generates the first video based on the special-effect sticker, acquires the interaction content from the user, and generates the second video according to the first video and the additional special effect that matches the interaction content. Since different interaction content will be generated for different users and will correspond to different additional special effects, the additional special effects that match the interaction content can reflect users' personalized choices relevant to the users. Therefore, the second video can display a personalized video display effect relevant to the user. Compared with using only the special-effect sticker as a single video effect, co-displaying can improve the diversification and the personalization of the video effects.

FIG. 6 is a block diagram of another electronic device 600 in accordance with exemplary embodiment. For example, the electronic device 600 is optionally a mobile phone, a computer, a digital broadcasting terminal, a messaging device, a game console, a tablet device, a medical device, a fitness device, a personal digital assistant, and the like.

In addition to the processor 601 and the memory 602, the electronic device 600 further includes at least one of the following components: a power component 603, a multimedia component 604, an audio component 605, an input/output (I/O) interface 606, a sensor component 607, and a communication component 608.

The processor 601 typically controls overall operations of the electronic device 600, such as the operations associated with display, telephone calls, data communications, camera operations, and recording operations. The processor 601 may include at least one processor 601 to execute instructions to perform all or part of the steps in the above described method for generating the video. Moreover, the processor 601 optionally includes at least one module which facilitates the interaction between the processor 601 and other components. For instance, the processor 601 may include a multimedia module to facilitate the interaction between the multimedia component 604 and the processor 601.

The memory 602 is configured to store various types of data to support the operation of the electronic device 600. Examples of such data include instructions for any applications or methods operated on the electronic device 600, contact data, phonebook data, messages, pictures, videos, and the like. The memory 602 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or an optical disk.

The power component 603 provides power to various components of the electronic device 600. The power component 603 may include a power management system, at least one power source, and any other components associated with the generation, management, and distribution of power in the electronic device 600.

The multimedia component 604 includes a screen providing an output interface between the electronic device 600 and a user. In some embodiments, the screen includes a liquid crystal display (LCD) and a touch panel (TP). If the screen includes a touch panel, the screen can be implemented as a touch screen to receive input signals from the user. The touch panel includes at least one touch sensor to sense touch and slide operations, and gestures on the touch panel. The touch sensor not only senses boundaries of the touch or slide actions, but also detects durations and pressures associated with the touch or slide operations. In some embodiments, the multimedia component 604 includes camera, and the camera includes a front camera and/or a rear camera. The front camera and the rear camera may receive external multimedia data while the electronic device 600 is in an operation mode, such as a photographing mode or a video mode. Each of the front camera and the rear camera may be a fixed optical lens system or have a focus and optical zooming capability.

The audio component 605 is configured to output and/or input audio signals. For example, the audio component 605 includes a microphone (“MIC”) configured to receive an external audio signal when electronic device 600 is in an operation mode, such as a call mode, a recording mode and a voice recognition mode. The received audio signal may be further stored in the memory 602 or transmitted via the communication component 608. In some embodiments, the audio component 605 further includes a speaker configured to output an audio signal.

The I/O interface 606 provides an interface between the processor 602 and peripheral interface modules. The peripheral interface modules are optionally a keyboard, a click wheel, buttons, and the like. The buttons may include, but are not limited to, a home button, a volume button, a start button, and a lock button.

The sensor component 607 includes at least one sensor to provide status assessments of various aspects of the electronic device 600. For instance, the sensor component 607 may detect an on/off status of the electronic device 600, relative positioning of components, e.g., the display and the keypad, of the electronic device 600, a change in position of the electronic device 600 or a component of the electronic device 600, a presence or absence of user contact with the electronic device 600, an orientation or an acceleration/deceleration of the electronic device 600, and a change in temperature of the electronic device 600. The sensor component 607 may include a proximity sensor configured to detect the presence of nearby objects without any physical contact. The sensor component 607 may also include a light sensor, such as a CMOS or CCD image sensor, for use in imaging applications. In some embodiments, the sensor component 607 may also include an acceleration sensor, a gyro sensor, a magnetic sensor, a pressure sensor, or a temperature sensor.

The communication component 608 is configured to facilitate wired or wireless communication between the electronic device 600 and other devices. The electronic device can access a wireless network based on a communication standard, such as Wi-Fi, a service provider network (2G, 3G, 4G, or 5G), or a combination thereof. In one exemplary embodiment, the communication component 608 receives a broadcast signal or broadcast associated information from an external broadcast management system via a broadcast channel. In one exemplary embodiment, the communication component 608 further includes a Near Field Communication (NFC) module to facilitate short-range communications.

In exemplary embodiments, the electronic device 600 may be implemented with at least one of an application specific integrated circuit (ASIC), a digital signal processor (DSP), a digital signal processing device (DSPD), a programmable logic device (PLD), a field-programmable gate array (FPGA), a controller, a micro-controller, microprocessor, or other electronic components, for performing the above method for generating the video.

In exemplary embodiments, a non-transitory computer-readable storage medium including instructions is further provided, such as the memory 602 including instructions. These instructions may be executed by the processor 601 in the electronic device 600 for performing the above method. For example, the non-transitory computer-readable storage medium may be a ROM, a Random Access Memory (RAM), a Compact Disc Read-Only Memory (CD-ROM), a magnetic tape, a floppy disc, an optical data storage device, or the like.

An embodiment of the present disclosure provides a non-transitory computer-readable storage medium storing an instruction, and the instruction, when executed by the processor 601 of the electronic device 600, enables the electronic device 600 to perform the steps of the method for generating the video in any one of the embodiments of the present disclosure.

In an exemplary embodiment, there is also provided a non-transitory computer-readable storage medium including instructions, such as the memory 602 including the instructions which are executable by the processor 601 to complete the above method for generating the video; or the memory 602 including the instructions which are executable by the processor 601 of the electronic device 600 to complete the above method for generating the video in any one of the embodiments. For example, the non-transitory computer-readable storage medium may be a ROM, a RAM, a CD-ROM, a magnetic tape, a floppy disk, an optical data storage device, or the like.

An embodiment of the present disclosure further provides a computer program product storing an instruction, and the computer program product, when running on the electronic device 600, enables the electronic device 600 to perform the steps of the method for generating the video in any one of the embodiments of the present disclosure.

In the above embodiments, all or part of the steps are implemented by software, hardware, firmware, or any combination thereof. When implemented using software, all or part of the steps may be implemented in the form of a computer program product. The computer program product stores at least one computer instruction. Computer program instructions are loaded and executed on a computer to produce all or part of processes or functions according to the embodiments of the present application. The computer is optionally a general-purpose computer, a special-purpose computer, a computer network, or other programmable devices. The computer instructions are stored in a computer-readable storage medium or transmitted from one computer-readable storage medium to another computer-readable storage medium. For example, the computer instructions are transmitted from one website, computer, server, or data center to another website, computer, server or data center, by such wired means as a coaxial cable, an optical fiber and a digital subscriber line (DSL), or such wireless means as infrared rays, radio and microwaves. The computer-readable storage medium is any available medium accessible to the computer, or such data storage devices as a server and a data center integrated with at least one available medium. The computer-readable storage medium is optionally a magnetic medium, such as a floppy disk, a hard disk and a magnetic tape; an optical medium, such as a digital versatile disc (DVD); or a semiconductor medium, such as a solid-state disk (SSD).

Other embodiments of the present disclosure will be apparent to those skilled in the art from consideration of the description and practice of the present disclosure. The present disclosure is intended to cover any variations, uses, or adaptations of the present disclosure following the general principles thereof and including common knowledge or commonly used technical measures which are not disclosed herein. The description and embodiments are to be considered as exemplary only, with a true scope and spirit of the present disclosure indicated by the appended claims.

The various embodiments in the description are described in a related manner, the same or similar parts between the various embodiments may be referred to each other, and each embodiment focuses on the differences from the other embodiments. In particular, for the embodiments of the apparatus and the electronic device, since these embodiments are basically similar to the method embodiment, the description is relatively simple, and the relevant parts may be referred to the description of the method embodiment.

In this context, relational terms such as first and second are used merely to distinguish one entity or operation from another entity or operation, and do not necessarily require or imply any actual relationship or order between these entities or operations. The term “including”, “include” or any other variants thereof is intended to cover a non-exclusive inclusion, such that a process, method, article or device that includes a series of elements includes not only those elements but also other elements that are not specifically listed, or further includes elements that are inherent to such a process, method, item or device. An element that is defined by the phrase “including a . . . ” does not exclude the presence of additional equivalent elements in the process, method, item or device that includes the element.

It will be appreciated that the present disclosure is not limited to the exact construction that has been described above and illustrated in the accompanying drawings, and that various modifications and changes can be made without departing from the scope thereof. It is intended that the scope of the present disclosure only be subject to the appended claims.

What is claimed is:

1. A method for generating a video, applicable to an electronic device, the method comprising:
in response to a select operation on a special-effect sticker, displaying interaction information corresponding to the special-effect sticker;
acquiring interaction content from a user, the interaction content being generated based on the interaction information;
acquiring a first video to be displayed, the first video being generated based on the special-effect sticker; and
generating a second video based on the first video and an additional special effect that matches the interaction content.

2. The method according to claim 1, wherein the interaction content comprises at least one of a subject-specific option, a dragged picture material in a display interface, a placement location of the dragged picture material, an input text, an input emoji, an uploaded picture, an uploaded video, and a shot picture.

3. The method according to claim 1, wherein in the case that the additional special effect comprises non-audio data, generating the second video based on the first video and the additional special effect that matches the interaction content comprises:
determining target image data corresponding to the additional special effect according to the additional special effect that matches the interaction content; and
synthesizing the target image data and a video frame of the first video into the second video.

4. The method according to claim 1, wherein in the case that the additional special effect comprises non-audio data, generating the second video based on the first video and the additional special effect that matches the interaction content comprises:
obtaining the second video containing the additional special effect by adding the additional special effect to a video frame of the first video.

5. The method according to claim 1, wherein in the case that the additional special effect comprises audio data, generating the second video based on the first video and the additional special effect that matches the interaction content comprises:
obtaining the second video containing the additional special effect by synthesizing audio data in the additional special effect and a video frame of the first video.

6. The method according to claim 1, further comprising:
searching for, according to the interaction content, the additional special effect that matches the interaction content from a pre-stored corresponding relationship between the interaction content and the additional special effect.

7. The method according to claim 1, wherein the additional special effect comprises at least one of a picture, a text, an audio, and a video.

8. The method according to claim 1, further comprising: playing the second video.

9. An electronic device, comprising:
a processor; and
a memory configured to store at least one instruction executable by the processor;
wherein the processor is configured to execute the at least one instruction stored in the memory to:
display interaction information corresponding to the special-effect sticker in response to a select operation on a special-effect sticker;
acquire interaction content from a user, the interaction content being generated based on the interaction information;
acquire a first video to be displayed, the first video being generated based on the special-effect sticker; and
generate a second video based on the first video and an additional special effect that matches the interaction content.

10. The electronic device according to claim 9, wherein the interaction content comprises at least one of a subject-specific option, a dragged picture material in a display interface, a placement location of the dragged picture material, an input text, an input emoji, an uploaded picture, an uploaded video, and a shot picture.

11. The electronic device according to claim 9, wherein in the case that the additional special effect comprises non-audio data, the processor is configured to execute the at least one instruction stored in the memory to:
determine target image data corresponding to the additional special effect; and
synthesize the target image data and a video frame of the first video into a second video.

12. The electronic device according to claim 9, wherein in the case that the additional special effect comprises non-audio data, the processor is configured to execute the at least one instruction stored in the memory obtain the second video containing the additional special effect by adding the additional special effect to a video frame of the first video.

13. The electronic device according to claim 9, wherein in the case that the additional special effect comprises audio data, the processor is configured to execute the at least one instruction stored in the memory to obtain the second video containing the additional special effect by synthesizing the audio data in the additional special effect and a video frame of the first video.

14. The electronic device according to claim 9, wherein the processor is configured to execute the at least one instruction stored in the memory to search for, according to the interaction content the additional special effect that matches the interaction content from a pre-stored corresponding relationship between the interaction content and the additional special effect.

15. The electronic device according to claim 9, wherein the additional special effect comprises at least one of a picture, a text, an audio, and a video.

16. The electronic device according to claim 9, wherein the processor is configured to execute the at least one instruction stored in the memory to play the second video.

17. A non-transitory computer-readable storage medium storing at least one instruction therein in an electronic device, wherein the at least one instruction, when executed by a processor of the electronic device, enables the electronic device to:
display interaction information corresponding to the special-effect sticker in response to a select operation on a special-effect sticker;
acquire interaction content from a user, the interaction content being generated based on the interaction information;
acquire a first video to be displayed, the first video being generated based on the special-effect sticker; and
generate a second video based on the first video and an additional special effect that matches the interaction content.

18. The storage medium according to claim 17, wherein the interaction content comprises at least one of a subject-specific option, a dragged picture material in a display interface, a placement location of the dragged picture material, an input text, an input emoji, an uploaded picture, an uploaded video, and a shot picture.

19. The storage medium according to claim 17, wherein in the case that the additional special effect comprises non-audio data, the at least one instruction, when executed by the processor of the electronic device, enables the electronic device to:
determine target image data corresponding to the additional special effect; and
synthesize the target image data and a video frame of the first video into the second video.

20. The storage medium according to claim 17, wherein in the case that the additional special effect comprises non-audio data, the instruction in the storage medium, when executed by the processor of the electronic device, enables the electronic device to perform the following operation:
obtaining the second video containing the additional special effect by adding the additional special effect to a video frame of the first video.
